(19) United States
(12) Patent Application Publication
(10) Pub. No.: US 2012/0131734 A1
(43) Pub. Date: May 31, 2012

(54) Fire resistant coverall with firearm access portal

(76) Inventor: Diana K. Sindicich, Tallahassee, FL (US)

(21) Appl. No.: 11/881,327

(22) Filed: Jul. 26, 2007

Related U.S. Application Data
(60) Provisional application No. 60/833,434, filed on Jul. 26, 2006.

(51) Int. Cl. A62B 17/00; A41D 13/02

(52) U.S. Cl. 2/458; 2/79

(57) ABSTRACT

A fire and chemical resistant coverall suitable for use by fire investigators. The coveralls are preferably made of a three-layer laminate. The outer layer is heat and moisture resistant. The middle layer provides additional thermal protection. The inner layer—which will lie next to the wearer's skin in some regions—is selected for its tactile properties. The coverall is sized to fit loosely over a law enforcement officer's normal uniform. It includes a loose-fitting waist section in order to provide clearance for an officer's utility belt and firearm. A firearm access port is located on the waist, proximate where a hip holster is worn. This port allows the wearer to reach through the coverall and retrieve a firearm stored in a holster on a utility belt. The firearm port is covered by a protective flap which ordinarily remains closed.

### CROSS-REFERENCES TO RELATED APPLICATIONS

This application claims the benefit of the filing date of a provisional application, Application Ser. No. 60/833,434 which names the same inventor.

### STATEMENT REGARDING FEDERALLY SPONSORED RESEARCH OR DEVELOPMENT

Not Applicable.

### MICROFICHE APPENDIX

Not Applicable.

### BACKGROUND OF THE INVENTION

1. Field of the Invention

This invention relates to the field of clothing. More specifically, the invention comprises a fire resistant coverall which includes a waist-level access port permitting access to a firearm carried on a belt.

2. Description of the Related Art

Specialized clothing has been developed for firefighters. Most are two piece sets. A pair of heavy pants are worn over a light inner layer. These are typically supported by wide suspenders. A long overcoat is added after the pants are in place. The overcoat's lower extreme extends well below the waist of the pants. This overlap prevents the intrusion of hot gas, water, and flames. The overlap also allows the firefighter to bend and stoop without exposure.

Although the traditional two-piece firefighting suit provides good thermal insulation, it is both bulky and heavy. A firefighter actively engaged in firefighting can tolerate such a suit because (1) The benefit of extreme heat protection outweighs the discomfort of wearing it; and (2) Those firefighters near the blaze are often spraying water from hoses, which serves to cool them somewhat.

Fire investigators often wear the same clothing as firefighters. A fire investigator ideally arrives on a fire scene shortly after the firefighters themselves. However, a fire investigator is not actively involved with fighting the fire and will typically only enter an area where the fire has been extinguished.

Such areas are not free of risks, however. Flare ups are still possible. Embers, hot steam, hot dripping water, and fire retarding foam may still be found in an extinguished area. Thus, many fire investigators choose to don traditional fire fighting clothing. Although the degree of protection provided by such clothing is extensive, it is often ill-suited to the fire investigator. The investigator must remain on the scene for an extended period—often several hours. The substantial weight and thermal insulation of the traditional firefighting gear can become oppressive over such a period.

Unlike firefighters, fire investigators are often uniformed law enforcement officers. They typically wear a utility belt mounting a firearm, a flashlight, a set of handcuffs, a radio, etc. These items do not fit well under a firefighting coat, nor can they be accessed through a firefighting coat. Thus, if a fire investigator is called to a fire scene, he or she must often remove the normal uniform and change into a completely different firefighting outfit.

It is impractical for most uniformed officers to carry around a second bulky set of clothing. Thus, requiring a change into a firefighting outfit causes a delay in reaching the scene. Fire cause and origin evidence—which often has a short life—may be lost during this delay.

Many times the fire investigator is the first (and sometimes the only) law enforcement officer on a fire scene. The investigator may therefore be called upon to fulfill traditional police duties—such as apprehending a suspect. In such an instance, the investigator needs ready access to conventional police gear. It is therefore desirable to provide suitable clothing which could be donned over the existing law enforcement uniform. The present invention accomplishes this goal.

### BRIEF SUMMARY OF THE INVENTION

The present invention is a fire and chemical resistant coverall suitable for use by fire investigators. The coveralls are preferably made of a three-layer laminate. Although the term “laminate” is used, the surfaces of the materials need not be physically bonded together. Instead, the term “laminate” as used herein merely describes materials that are stacked together one-on-top of the other. The outer layer is heat and moisture resistant. The middle layer provides additional thermal protection. The inner layer—which will lie next to the wearer's skin in some regions—is selected for its tactile properties.

The coverall is sized to fit loosely over a law enforcement officer's normal uniform. It includes a loose-fitting waist section in order to provide clearance for an officer's utility belt and firearm. A firearm access port is located on the waist, proximate where a hip holster is worn. This port allows the wearer to reach through the coverall and retrieve a firearm stored in a holster on a utility belt. The firearm port is covered by a protective flap which ordinarily remains closed.

The coverall preferably includes other features as well. Storage pockets can be provided on the chest, the arms, and legs. The coveralls can also include an external hanging loop for a pair of handcuffs and legs. Other conventional features found on other firefighting garments—such as reflective stripes—are preferably included as well.

### BRIEF DESCRIPTION OF THE SEVERAL VIEWS OF THE DRAWINGS

FIG. 1 is an elevation view, showing a front view and a rear view of the coveralls.

FIG. 2 is a detail perspective view, showing the chest region.

FIG. 3 is a section view, showing the coverall's preferred three-layer construction.

FIG. 4 is a detail perspective view, showing the firearm port.

FIG. 5 is a detail perspective view, showing the firearm port covered by the port flap.

FIG. 6 is a hidden line perspective view, showing the positioning of the firearm port over a firearm located on a utility belt under the coveralls.

FIG. 7 is an elevation viewing, showing an alternate embodiment of the present invention.

REFERENCE NUMERALS IN THE DRAWINGS

| | | | |
|---|---|---|---|
| 10 | coverall | 12 | leg |
| 14 | waist | 16 | sleeve |
| 18 | chest | 20 | arm cuff |
| 22 | wrist cinch strap | 24 | visibility stripe |
| 26 | collar | 28 | closure flap |
| 30 | firearm port | 32 | leg cuff |
| 34 | ankle cinch strap | 36 | knee pocket |
| 38 | chest pocket | 40 | label |
| 42 | elastic gather | 44 | handcuff strap |
| 46 | pocket flap | 48 | loop panel |
| 50 | hook panel | 52 | outer layer |
| 54 | middle layer | 56 | inner layer |
| 58 | opening | 60 | loop panel |
| 62 | port flap | 64 | hook panel |
| 66 | loop panel | 68 | hook panel |
| 70 | belt | 72 | holster |
| 74 | firearm | | |

### DETAILED DESCRIPTION OF THE INVENTION

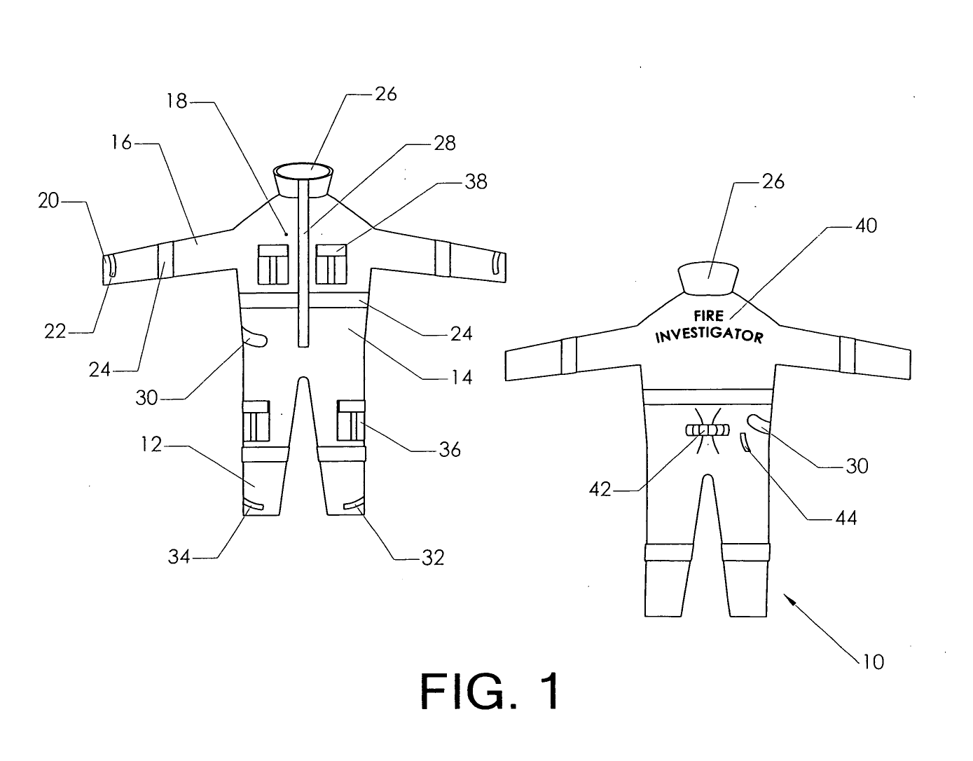

FIG. 1 shows an overall view of coverall 10. The depiction on the left side of the view shows a front view of the coverall while the depiction on the right side shows a rear view. With reference to the front view, the reader will observe that many features of the coverall are conventional. Waist 14 is joined to a pair of legs 12. Chest 18 is joined to a pair of sleeves 16.

The coverall is designed to protect the wearer from the intrusion of hot water, steam, chemical residues, and the like. Collar 26 stands up from the top of the chest portion. The collar's rear extreme is higher than the front, in order to protect the wearer's neck. A long opening running vertically through the coverall's front is closed by closure flap 28. Closure flap 28 acts to seal the trunk opening in coverall 10. The opening and closure flap extend up through collar 26.

The opening and closure flap can assume many forms. As an example, the opening could be closed by a vertical zipper, with closure flap 28 then snapping or buttoning over the zipper. However, it is preferable to use VELCRO-type hook and loop panels instead of zippers and snaps. The underside of the closure flap is provided with a hook panel or panels, while loop panels are provided on the portions of the coverall which the closure flap will contact when it is pressed in place. With this arrangement, the wearer can easily don or remove the coverall.

It is desirable to seal the two leg cuffs 32 and arm cuffs 20. The leg openings may be designed large enough to go over the shoes or boots of the wearer. A pair of ankle cinch straps 34 are provided to seal the leg cuffs, while a pair of wrist cinch straps 22 are provided to seal the wrist cuffs. These cinch straps are preferably secured via hook and loop panels—as for the closure flap. However, they can also be secured via buckles, snaps, or similar hardware. Whatever closure hardware is used, it should be adjustable to allow the cinching of the cuff opening around a variety of ankle and wrist sizes. Other features which are common to prior art firefighting garb may also be included. Visibility stripes 24 are made from highly reflective material, so that the wearer can be located in a dark and/or smoky environment. Knee pockets 36 and chest pockets 38 are provided for external storage of equipment.

Firearm port 30, which will be explained in detail subsequently, is located in waist 14. It can be located on the garment's right side, left side, or on both sides. It is positioned to lie approximately over a firearm worn on a utility built beneath the coverall.

The depiction on the right side of FIG. 1 shows the coverall from the rear. The reader will note how the rear of collar 26 projects upward. The coverall is intended to be worn with a safety helmet (possibly a fireman's helmet and face shield). The collar helps ensure that any material (such as hot water) which flows off the helmet will not enter the coverall.

The coverall's waist is preferably made large in order to fit loosely around a bulky utility belt worn underneath. Elastic gather 42 may be provided across the lumbar region in order to collect loose folds of fabric which can expand if a larger circumference is needed.

Firearm port 30 is shown with its covering flap closed. Handcuff strap 44 is provided to externally mount a pair of handcuffs. Although a strap is illustrated, a pouch may be provided instead for holding the handcuffs. Label 40 is preferably provided to identify the wearer. A text message such as “FIRE INVESTIGATOR” or “SHERIFF'S DEPARTMENT” can be printed in this region. A graphical element (such as a sheriffs star) can also be included. Other pockets and loops can be added.

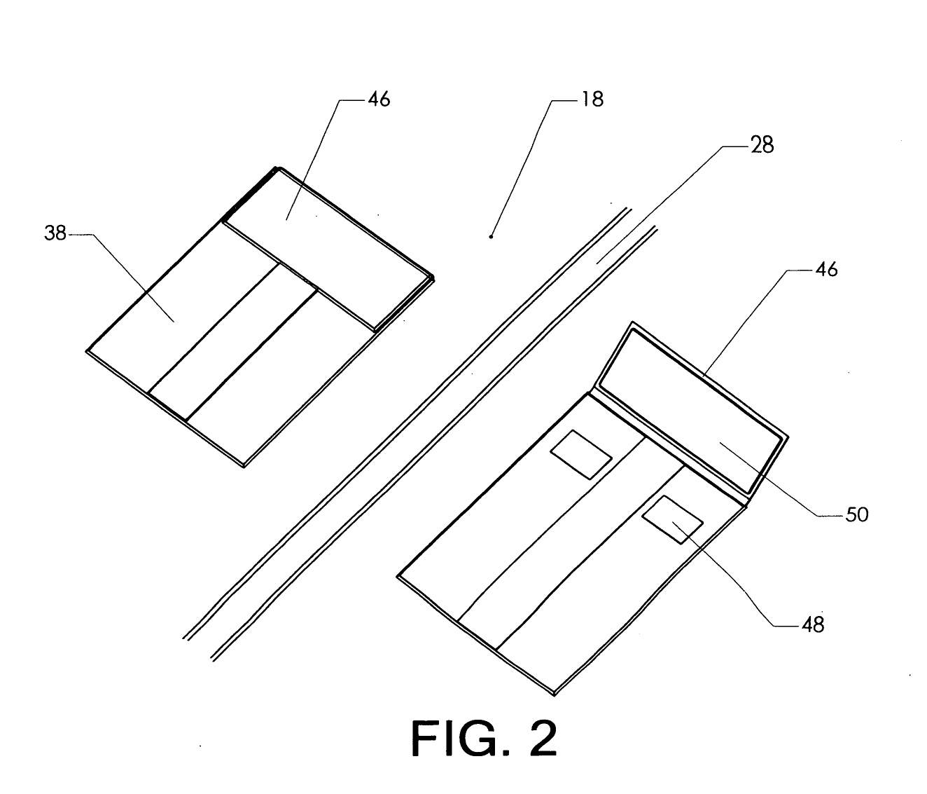

FIG. 2 shows some detail of chest 18. Two chest pockets 38 are provided. These are preferably bellows-type pockets which can expand to house larger pieces of equipment. The wearer will likely be wearing protective gloves, so pocket closures should be easy to manipulate. Pocket flap 46 is closed by pressing hook panel 50 (on its underside) against one or more loop panels 48 on the pocket's exterior.

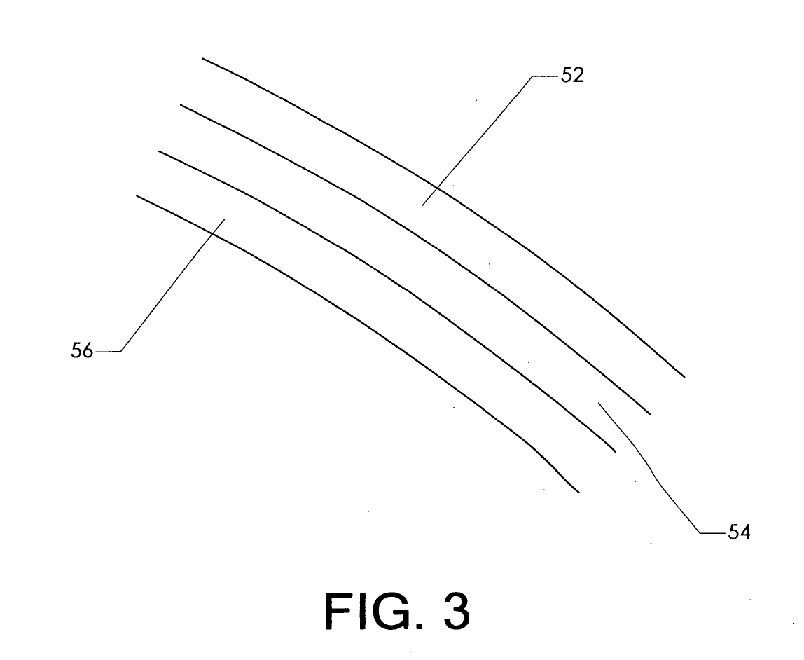

FIG. 3 is a cross section through the fabric used in the coverall. It preferably includes three layers: outer layer 52, middle layer 54, and inner layer 56. Many suitable materials exist. However, the use of MILLENIA for the outer layer, STEDAIR 3000 for the middle layer, and CALDURA SL for the inner layer, has been shown to be an effective combination. MILLENIA is a 7.5osy fabric rated to 1300 degrees Fahrenheit. It is highly water resistant.

STEDAIR 3000 is a brand of film-bonded nomex. It provides additional thermal protection. CALDURA SL is another type of nomex which has improved tactile properties. Since it will possibly contact some of the user's skin, these improved tactile properties are significant.

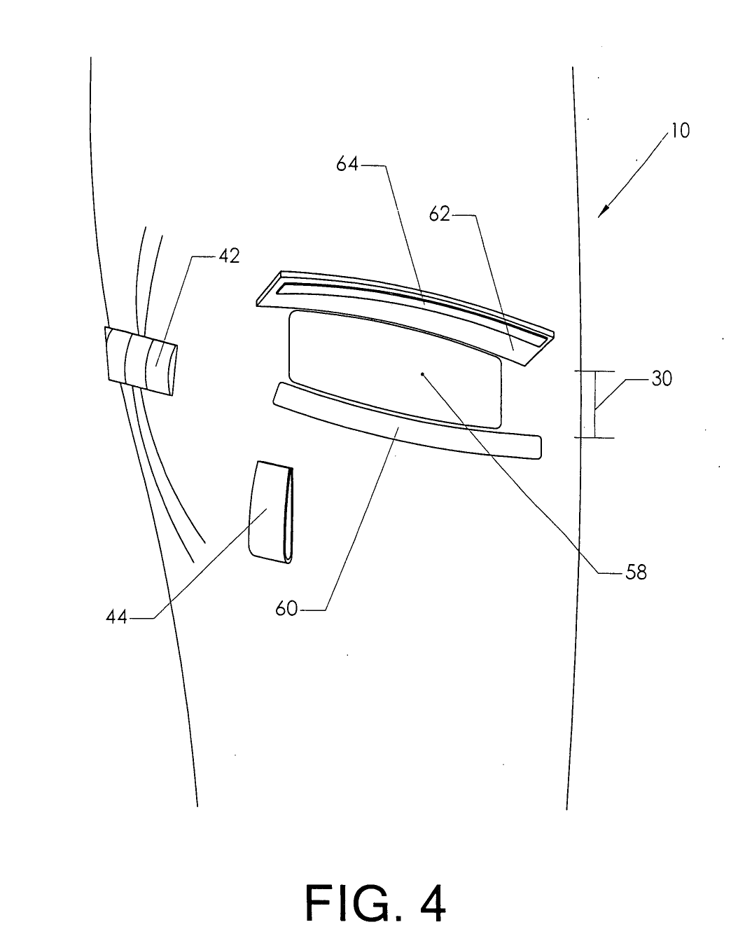

FIG. 4 is a perspective view of the waist region. Firearm port 30 defines opening 58 through the coverall. The opening is bounded by a seam. It can be formed by stitching, adhesives, or other known approaches. Port flap 62 is bonded to the coverall along the upper edge of opening 58. Its underside includes a VELCRO hook panel 64, which can be pressed against loop panel 60 on the coverall.

The reader will note that the firearm port is preferably angled, with its forward extreme being lower than its rear extreme. This angle facilitates the extraction of the firearm. The embodiment shown is for a right-handed user drawing from a holster on his or her right hip. The right hand is passed through the opening. The user then grasps the firearm, pulls it free of its holster, and withdraws it through the opening. Those skilled in the art will readily appreciate how the angled opening makes this process easier.

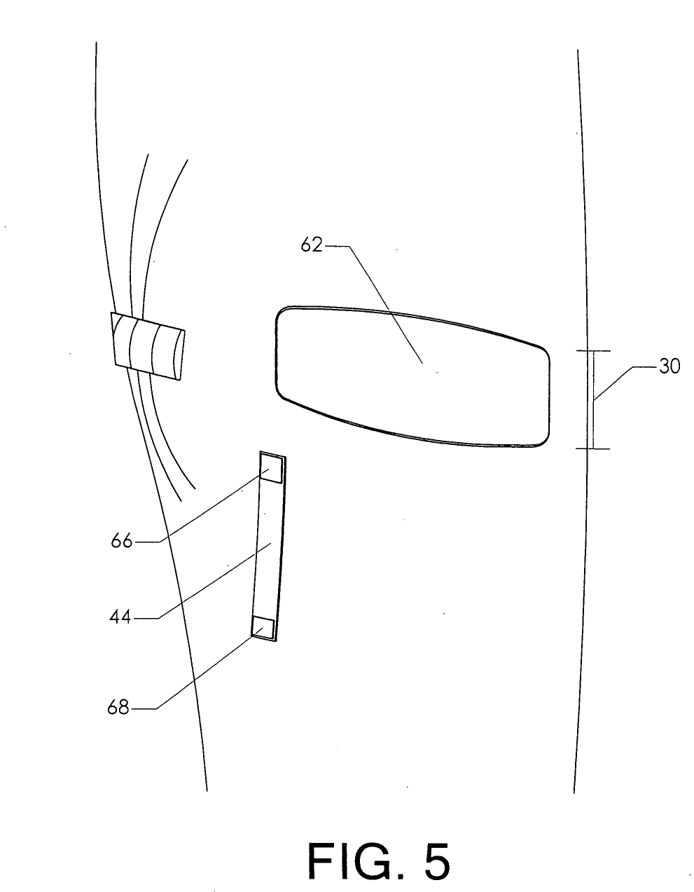

FIG. 4 also shows handcuff strap 44 which is used to externally secure a pair of handcuffs. This is preferably located around the side of the waist region, so that the wearer can easily reach around and retrieve the handcuffs. FIG. 5 shows the same region, with hand cuff strap 44 being opened. To attach the handcuffs, the user passes the strap around the handcuffs and then presses hook panel 68 against loop panel 66. Snaps or buckles could again be used in place of the VELCRO securing means. However, since the user will typically be wearing gloves, the hook and loop approach is preferred.

FIG. 5 shows firearm port 30 with port flap 62 secured in the closed position. When thus secured it closes the firearm port and prevents the intrusion of hazardous materials. Port flap 62 is made larger than opening 58 in order to provide a protective overlap.

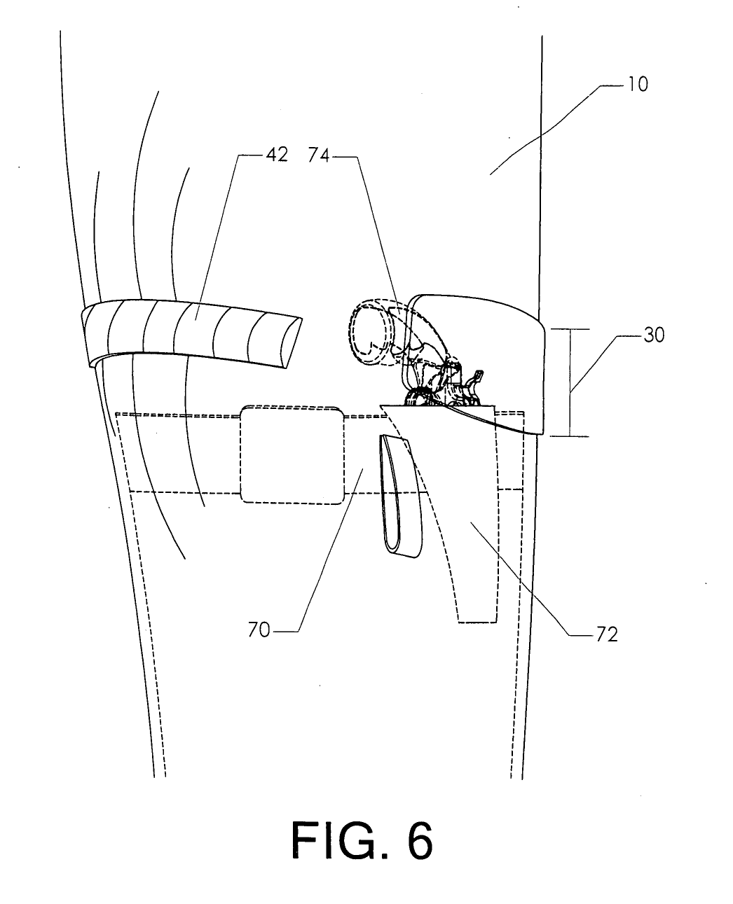

FIG. 6 shows a hidden line view of the coverall's waist. The dashed lines show a belt 70 being worn around the user's waist. Holster 72 secures firearm 74 in position. The position shown is typical for a right-handed user, who carries a pistol on his or right hip. Firearm port 30 lies over the position of the firearm. The user can flip open the port cover and retrieve the fire arm using only one hand.

The position shown in FIG. 6 is for a right-handed user. A firearm port can also be provided on the left side of the waist, which would be suitable for a left-handed user. It is also possible to provide the coverall with firearm ports on both sides. In that case, the user would simply leave the redundant port unopened.

FIG. 6 shows how elastic gather 42 preferably draws the relatively loose fitting waist region around the utility belt. This helps to correctly position the firearm port near the firearm. The elastic gather is effective in this regard, though one could also substitute an adjustable belt around the waist, additional VELCRO-secured cinches, or small side belts with adjusting buckles.

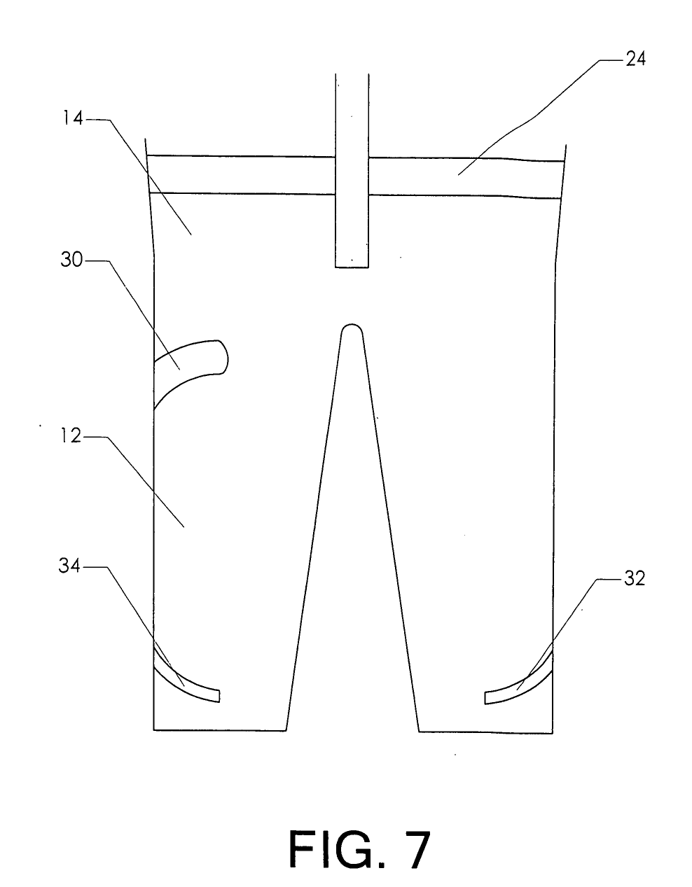

The preceding description contains significant detail regarding the novel aspects of the present invention. It should not be construed, however, as limiting the scope of the invention but rather as providing illustrations of the preferred embodiments of the invention. As an example, many different fabric materials could be substituted for the three disclosed in detail. Also, firearm port 30 may be provided in various locations. As illustrated in FIG. 7, firearm port 30 may be placed in the coverall over the wearer's thigh. This placement of firearm port 30 in this position allows access to a thigh-mounted pistol for a person who wears his or her pistol mounted to the thigh. Accordingly, the scope of the invention should be fixed by the following claims, rather than by the examples given.

Having described my invention, I claim:

1. A coverall to be worn by a user carrying a firearm, said user having a neck, a chest, a waist, a right arm, a left arm, a right leg, and a left leg, comprising:
a. a chest portion configured to cover said chest of said user, said chest portion having a neck opening adapted to encircle said neck of said user;
b. a waist portion attached to said chest portion, said waist portion configured to encircle said waist of said user;
c. a right sleeve attached to said chest portion, said right sleeve adapted to cover said right arm of said user;
d. a left sleeve attached to said chest portion, said left sleeve adapted to cover said left arm of said user;
e. a right leg portion attached to said waist portion, said right leg portion adapted to cover said right leg of said user;
f. a left leg portion attached to said waist portion, said left leg portion adapted to cover said left leg of said user;
g. a trunk opening in said chest portion extending between said waist portion and said neck opening for donning said coverall;
h. a firearm access port in at least one of said chest portion, said waist portion, said right leg portion, and said left leg portion, said firearm access port having an opening and a continuous perimeter therearound, said opening of said firearm access port passing completely through said coverall, said firearm port positioned and adapted so that said user can grab, unholster, and remove said firearm through said firearm access port without opening said trunk opening;
i. a flap, adapted to cover said firearm access port; and
j. wherein said chest portion, said waist portion, said right sleeve, said left sleeve, said right leg portion, and said left leg portion comprise a fire-resistant material.

2. The coverall of claim 1, wherein said chest portion said waist portion, said right sleeve, said left sleeve, said right leg portion, sand said left leg portion comprise an outer layer, an inner layer, and a middle layer therebetween.

3. The coverall of claim 1, wherein said fire-resistant material is fire resistant to at least approximately 1300 degrees Fahrenheit.

4. The coverall of claim 2, wherein said outer layer comprises said fire-resistant material, said fire-resistant material is fire resistant to at least approximately 1300 degrees Fahrenheit.

5. The coverall of claim 2, wherein said middle layer comprises a film-bonded nomex.

6. The coverall of claim 1, said flap having a first edge and a second edge, said first edge stitched to said coverall proximate said firearm access port, said second edge extending across said opening of said firearm access port where said flap is removably fastened to said coverall.

7. A coverall to be worn by a user carrying a firearm, said user having a neck, a chest, a waist, a right arm, a left arm, a right leg, and a left leg, comprising:
a. a unitary garment adapted to cover said chest, said waist, said right arm, said left arm, said right leg, and said left leg of said user when worn;
b. a neck opening adapted to encircle said neck of said user;
c. a trunk opening in said garment, said trunk opening extending from said neck opening to at least said waist of said user when worn;
d. a firearm access port in said garment, said firearm access port having an opening and a continuous perimeter therearound, said firearm port positioned and adapted so that said user can grab, unholster, and remove said firearm through said firearm access port without opening said trunk opening; and
e. wherein said garment comprises a fire-resistant material.

8. The coverall of claim 7, further comprising a flap adapted to cover said firearm access port.

9. The coverall of claim 7, wherein said garment comprises an outer layer, an inner layer, and a middle layer therebetween.

10. The coverall of claim 7, wherein said fire-resistant material is fire resistant to at least approximately 1300 degrees Fahrenheit.

11. The coverall of claim 9, wherein said outer layer comprises said fire-resistant material, said fire-resistant material is fire resistant to at least approximately 1300 degrees Fahrenheit.

12. The coverall of claim 9, wherein said middle layer comprises a film-bonded nomex.

13. The coverall of claim 8, said flap having a first edge and a second edge, said first edge stitched to said coverall proximate said firearm access port, said second edge extending across said opening of said firearm access port where said flap is removably fastened to said coverall.

14. A coverall to be worn by a user carrying a firearm on a belt-mounted holster, said user having a neck, a chest, a waist, a right arm, a left arm, a right leg, and a left leg, comprising:
a. a unitary garment adapted to cover said chest, said waist, said right arm, said left arm, said right leg, and said left leg of said user when worn;
b. a neck opening adapted to encircle said neck of said user;
c. a trunk opening in said garment, said trunk opening extending from said neck opening to about said waist of said user when worn;
d. a firearm access port in said garment, said firearm access port having an opening and a continuous perimeter therearound, said firearm port positioned and adapted so that said user can grab said firearm, unholster said firearm from said belt-mounted holster, and remove said firearm through said firearm access port without opening said trunk opening when wearing said belt-mounted holster on said waist.

15. The coverall of claim 14, wherein said garment comprises a fire-resistant material.

16. The coverall of claim 14, further comprising a flap adapted to cover said firearm access port.

17. The coverall of claim 14, wherein said garment comprises an outer layer, an inner layer, and a middle layer therebetween.

18. The coverall of claim 15, wherein said fire-resistant material is fire resistant to at least approximately 1300 degrees Fahrenheit.

19. The coverall of claim 17, wherein said outer layer comprises said fire-resistant material, said fire-resistant material is fire resistant to at least approximately 1300 degrees Fahrenheit.

20. The coverall of claim 16, said flap having a first edge and a second edge, said first edge stitched to said coverall proximate said firearm access port, said second edge extending across said opening of said firearm access port where said flap is removably fastened to said coverall.
